(19) United States
(12) Patent Application Publication
(10) Pub. No.: US 2011/0116636 A1
(43) Pub. Date: May 19, 2011

(54) Intelligent File Encapsulation

(76) Inventor: Darren Steed, Warwickshire (GB)

(21) Appl. No.: 13/000,678

(22) PCT Filed: Jun. 26, 2009
(86) PCT No.: PCT/GB09/50737

§ 371 Date: Dec. 22, 2010

(30) Foreign Application Priority Data
Jun. 30, 2008 (GB) 0811897.8

(51) Int. Cl. H04L 9/08

(52) U.S. Cl. 380/281; 380/279

(57) ABSTRACT

An improved network-based system and network implemented method of distributing and controlling the release of an encapsulated content. The system comprising an archive creation tool configured to create a self-extractable archive comprising an encrypted content, distribution means adapted to distribute the archive to one or more users and a server arranged to remotely control a timed release of the content from each distributed archive by providing a decryption key in response to a key request received on or after a predetermined date and time. In this way, a publisher of the archive can control access to a content even after the archive has been distributed to one or more users. Due to executable functionality within the archive, an additional content, such as advertisements, multimedia files or other documents, can be presented to a user in response to extraction of the archive, without the need for client-based extraction software.

### BACKGROUND OF THE INVENTION

1. Field of the Invention

The present invention relates to file encapsulation and, in particular, to an improved system and method of distributing and controlling the release of an encapsulated content.

2. State of the Art

The growth of the Internet and the ubiquity of networked clusters of computers have allowed the distribution of digital media to expand significantly in recent years. It is now quite commonplace for individuals to download large numbers of media files, whether it be for recreation or other purposes, onto their personal computers, personal digital assistants (PDAs) and mobile phones etc. This mass downloading of media and other content has been greatly facilitated by the ever increasing usage of wide bandwidth download services, such as broadband Internet connections, within both office and home environments.

One of the most common tasks currently performed on the Internet is the downloading of digital multimedia files, such as music, images and videos etc., as well as the downloading of software and other data. At any particular time, there may be millions of files being downloaded by distributed users. It is known in the prior art to control the distribution and access to the content of such files by use of password protection, data encryption and digital signing. However, although such techniques provide some degree of security and control over the release of the content to an individual, there is no known single application or set of tools that permit a publisher to alter how, and when, their material is to be accessed after it has been distributed across the Internet.

There are many known techniques for altering the state of a digital media file, typically by way of compression and/or encryption. However, each of these techniques act directly on the data itself and consequently do not add any additional functionality to the altered file. Moreover, it is usually the case that external software is required in order to convert the altered file back into its original state. Thus, the handling of such files may be burdensome to an individual, as extra software may need to be installed to process the files before the content can be released. If an individual downloads large numbers of files, of many differing formats, the act of converting the files may become tedious and detrimental to the activities of the individual. In which case, he may decide to avoid particular file types or cease downloading altogether.

Internet sites that provide free downloads of media and content are often operated at a financial loss, as any revenue that they generate may typically be less than the combined cost of hosting the site and leasing the download bandwidth. Therefore, it is becoming increasingly more popular for sites to incorporate some form of ‘embedded advertising’, in which one or more advertisements are presented to an individual when they access the download site. A site owner may therefore generate a significant income stream by agreeing to display advertisements for third party vendors. The basic principle involves making space available on the website for an embedded section of HTML code, commonly referred to as an ‘ad-code’, which retrieves a particular hyperlinked advertisement from a third party management company whenever an individual visits the site. A management company may send different advertisements each time the same website is accessed, thereby broadening the exposure to more advertisements and increasing the number of clients that they can support.

The site owner receives income for every advertisement displayed on the website, and will gain further remuneration if an individual actually follows the hyperlink to the vendor's own website. In order for such an advertising campaign to the successful, it is necessary to tempt the individual to proceed to the vendor's site, the likelihood of which is increased markedly if the advertisement is targeted to the individual's interests and/or characteristics. However, the use of targeted advertisements can be quite difficult to implement in practice, as some a priori knowledge of the individual is required in order to select which advertisement is the most appropriate. Moreover, even if an advertisement can be targeted to the particular individual, the problem remains as to how to ensure that the individual reads, watches and/or listens to the advertisement in order to be sufficiently enticed to follow the link to the vendor's site.

### SUMMARY OF THE INVENTION

According to a first aspect of the present invention there is provided a network-based system adapted to distribute and control the release of an encapsulated content, the apparatus comprising:
an archive creation tool configured to create a self-extractable archive comprising an encrypted content;
distribution means adapted to distribute the archive to one or more users; and
a server arranged to remotely control a timed release of the content from each distributed archive by providing a decryption key in response to a key request received on or after a predetermined date and time.

The present invention seeks to address some or all of the above problems of the prior art by providing an improved network-based system and associated method that, together with a self-extractable archive having inherent intelligence and additional functionality, allows a publisher to control the distribution and release of a content even after the archive has been distributed to one or more individuals. Moreover, in providing such an archive, the invention gives rise to an advantageous mechanism by which additional functionality, such as in the form of targeted advertisements, may be presented to an individual to enhance their overall experience and enjoyment of the downloaded content.

The invention also provides a comprehensive set of tools that enables a publisher to exercise greater control over the distribution of his material and which permit properties of the material to be subsequently altered to thereby ensure secure delivery and release of the material to an individual.

Moreover, the invention is able to create archive files that have additional functionality and which possess an inherent intelligence, in that, content can be released according to a prescribed extraction procedure, without the action, or intervention, of any external client software.

The invention also advantageously allows targeted advertisements and/or other material of particular interest to be linked to downloadable content and provides a mechanism by which an individual is encouraged to review the advertisements/material prior to, during or subsequent to, extracting the downloaded content.

The present invention is implemented within a conventional network architecture and infrastructure, and is most preferably implemented with respect to the Internet or World-Wide-Web global network. However, it is to be understood that the invention may alternatively be implemented within variable sized intranets or other types of dedicated computing clusters having one or more centralised servers.

The network-based system of the first aspect of the invention comprises an archive creation tool configured to create a self-extractable archive. Preferably, the archive creation tool is a client-based application, herein referred to as a ‘Wrapper Application’, that is intended to reside and execute on a publisher's computer, such as a desktop, laptop or server etc. In preferred embodiments, the archive creation tool is a Microsoft Windows based-application, comprising a graphical user interface (GUI) designed to facilitate the creation of the archive. However, it should be appreciated that in different embodiments, the archive creation tool may be implemented on other computing platforms and under non-Windows based operating systems, without sacrificing any functionality or advantages of the invention.

By ‘publisher’ we mean any person, designer, design team or corporate entity comprising any one or more of the preceding, responsible for generating/compiling a content, and for creating an archive encapsulating that content, which is to be made available to the public or to a specified set of users.

The role of the archive creation tool is to provide a publisher with a dedicated, user-friendly application, which can encapsulate a desired content into a self-extractable archive. The content is commonly referred to as a ‘source material’ and may comprise any number of files or folders, or a is combination thereof. The files may include, but are not limited to, music, images, video, documents, data and software, in any desired combination. Therefore, it is evident that an archive may contain any number of different types of files, depending on the particular application and intended use of the content.

References herein to ‘encapsulate’ or ‘encapsulation’ are intended to encompass any technique of wrapping or packing the source material into the archive, which may involve compressing the material to increase packing efficiency and to minimise the overall size of the archive.

The archive is configured to be ‘self-extractable’, in the sense that, the archive is preferably an executable file comprising integral instructions that instruct the file how to unwrap and release the encapsulated content without relying on any external software on the user's computing device. In this way, the user can avoid the need to have any external extraction software on his device and can extract the archive by simply executing the file itself.

In accordance with the invention, the archive creation tool is configured to digitally encrypt content for inclusion in the archive. As a result, the encrypted content may be kept secure within the archive until it is released by way of a unique private decryption key. In preferred embodiments, the content is encrypted by the archive creation tool using a randomly generated private key, which is most preferably a 64 character key. The encryption standard preferably conforms to the Advanced Encryption Standard (AES), often referred to as ‘Rijndaer’. The AES is a known substitution-permutation network or block cipher, offering a high level of security for the encrypted content.

It is to be appreciated, however, that any other suitable encryption standard or encryption technique may be used in conjunction with any aspect of the present invention, without sacrificing the security of the archive or the integrity of the contents.

The distribution means is preferably a download server, and most preferably a web server, that is connected to the Internet. However, it is to be appreciated that archives may alternatively, or additionally, be distributed by way of a FTP server, via email, or by way of removable media, such as CD-ROM, DVD, a USB pen drive or tape etc. or in any other suitable way.

Once a publisher has created an archive, he preferably transfers the archive to the download server, whereupon it becomes available for download by any interested user.

The network-based system of the first aspect of the present invention further comprises a server arranged to remotely control a timed release of the content from each archive by providing a decryption key in response to a key request received on or after a predetermined date and time. The server is preferably a key server that is connected to the Internet and is remotely located with respect to both the archive creation tool and to the distributed archives. The role of the server is to allow a publisher of an archive to control how, and when, the encrypted content within an archive is to be released to a user. This is achieved by withholding a decryption key for that content until after a specified date and time. In this way, even if multiple copies of the archive have been distributed across the Internet, none of the users are able to access the content until the server releases the key.

The functionality to remotely control a timed release of a content after it has already been downloaded is particularly advantageous, as it provides the opportunity to publish and disseminate source material prior to an ‘official’ release date, without concern that the material will be made public. Hence, it is envisaged that the present invention may have particular application in distributing documents (e.g. examination papers and results, electronic is tickets) and media files (e.g. movie trailers, music, electronic books or software and games etc.) prior to public release, so as to lower the demands on download servers and to lessen Internet traffic on specific release dates.

Therefore, for example, as opposed to a particular download server attempting to handle numerous requests for a file on the first day of release, an encrypted version of the file may instead be downloaded well in advance of the release date. The only burden is then on the key server, which although must deliver the key to numerous users, will require significantly less bandwidth than a conventional download server.

In preferred embodiments, publishers can select a predetermined date and time for the release of the key, so that any corresponding archives will not be able to fully extract until after that date and time. As the system is secure, no tampering with the release date and time can occur. Therefore, the possibility of third parties gaining access to the encrypted contents of an archive earlier than expected are virtually non-existent.

Preferably, the self-extractable archive is configured to send a request for the decryption key to the key server in response to an extraction event. By ‘extraction event’ we mean the act, initiated by a user, of executing the archive file to attempt to extract its contents either before, at the time of, or subsequently to the predetermined date and time. Hence, depending on when the user performs an extraction event, he will either receive the key or be refused the key from the key server.

The key request is preferably in the form of an authenticated message that is automatically generated by the archive in response to each extraction event (e.g. once each time the user attempts to open the archive). The message is then sent to the key server, preferably via the Internet, whereupon the key server has authority to grant or refuse the request based on whether the request is valid and/or whether the key is currently available to be released having regard to the predetermined date and time.

In preferred embodiments, the archive includes instructions to control the extraction procedure, including at least knowledge as to how to generate a key request message for sending to the key server.

An archive may comprise further content, in addition to the encrypted content, including, but not limited to, any one or more of: advertising information, text-based documents, multimedia files and web-based material, which is configured to be presented to a user in response to an extraction event. In this way, an archive can thus be configured to include additional functionality, so that in response to an attempt to extract the archive, a content can be released to a user, irrespective of whether a key is currently available for the encrypted content.

By ‘presented’ we mean any form of visual and/or audio technique of conveying information to a user. Hence, the content may be displayed, audibly projected or both displayed and audibly projected to a user in response to an extraction event.

In this way, an archive having such additional functionality provides an advantageous mechanism by which advertisements or other particularly relevant information may be presented to a user while the archive is being extracted.

For instance, instead of an advertisement, the additional content may be in the form of a code segment that includes a URL or web address, which points to a streamable video or movie, such as a YouTube video etc. Moreover, it is also possible for the additional content to generate a webpage within a standalone browsing window that is spawned during extraction of the archive. The webpage may be navigable, thereby enabling a user to ‘surf’ specific content and/or related links and documents. In some applications, this could raise additional revenue for a publisher and/or management company.

To encourage a user to focus attention on the additional content, the archive includes instructions to delay the release of the encrypted content, even when a key is available, until the additional content has been presented to the user for a prescribed interval of time. As a result, if the additional content is an advertisement, for example, the user is then encouraged to inspect the advertisement while he waits for the release of the encrypted content. The interval of time is preferably in the range of 3 to 8 seconds, and is most preferably 5 seconds. However, any desired interval may be encoded within the archive depending on the particular application and time required to review the additional content.

The network-based system according to the first aspect of the present invention may further comprise a registration server configured to register and validate an archive by assigning one or more unique identifiers to the archive. The registration server is preferably connected to the Internet and is configured to communicate with the archive creation tool in order to validate any newly created archives. In particular, the registration server is preferably configured to provide a download identifier to the archive creation tool in response to its request. Preferably, the registration server initially verifies the request and if satisfied that the creation of the archive is authorised, will return the download identifier and will proceed to record pending details of the new archive.

Once a new archive is created, the archive creation tool preferably confirms successful creation of the archive with the registration server, and sends to it details of the archive, including at least the private encryption key and a date and time at which the key is to be released. The registered details, including the key and related date/time information, are then copied to the key server ready for subsequent use. In preferred embodiments, the registration server actually ‘pushes’ the details of the new archive onto the key server, which then uses database replication to ensure that all the archive details are up-to-date.

It is envisaged that the demands on the registration server will be significantly less than the demands on the key server, as the latter will have to handle multiple key requests for every registered archive.

The network-based system according to the first aspect of the present invention may further comprise an archive management tool configured to monitor the status and/or to modify one or more properties associated with an archive. The archive management tool, herein referred to as an ‘administration portal’, is preferably a web-based application that is intended to reside on top of the key server as an application layer. The role of the administration portal is to enable a publisher to view details related to his archives and, if necessary, to modify the status of one or more of the archives.

Hence, by way of the administration portal, a publisher is able to change the properties of an archive even after the archive has been distributed to multiple users. For instance, should a publisher subsequently decide that a content within a particular archive should be temporarily prevented from being released to the users, the publisher can then alter the status (i.e. enabled/disabled) and/or date on which the decryption key associated with that archive is to be provided. In this way, an archive can therefore be remotely disabled without the need to revoke or directly interact with the distributed archive file.

The administration portal thus greatly simplifies the mechanism by which the status and the properties of an archive can be monitored and altered. Moreover, the functionality provided by the administration portal can also improve the overall security and integrity of the downloadable archives, as for instance, should a virus or other form of malware be detected within a previously distributed archive, the publisher can then act quickly to prevent the further spread of the virus by disabling the archive, such that future requests for the decryption key are refused by the key server. In such a case, the archive could then be removed from the download server and replaced with a virus free version of the archive, for subsequent download by any affected users.

The management tasks undertaken by the administration portal may include viewing details associated with an archive, modifying the status of an archive (enabling/disabling), imposing a release date, modifying a release date and/or time, applying restrictions based on geographic location, inspecting content within an archive (both encrypted and additional content), viewing statistics associated with the archives and adding/editing messages to be provided by the key server in response to each key request. However, it is to be appreciated that the above tasks are not intended to be exhaustive and consequently the administration portal may be configured to perform any additional task that relates to the management and/or the maintenance of an archive.

The geographic location of a user may be used to impose restrictions on the release of a content from an archive. The location can be simply determined by way of the user's IP address, which can be interrogated at the time the archive is downloaded, or more preferably, at the time a key request is sent to the key server. Hence, if a certain content is to be prevented from being released in a particular country, due to local copyright law or for some other legitimate reason, the publisher may disable the archive in respect of all IP addresses associated with that country. In such an example, the use of the administration portal would be especially advantageous, as the publisher could control the release of the source material in multiple countries around the world by way of a single, centralised application.

The administration portal may also facilitate the establishment of a series of different dates and times for the release of a particular archive. The series may be selected to account for different time zones throughout the world, such that a local time for each respective country or territory may be registered with the key server in respect of the same archive. In this way, key requests established as originating from a certain country (e.g. by way of the user's IP address) can be checked against the date and time registered for that country, whereupon if the request is early, the key server will withhold the key until a subsequent request is received on or after that date and time.

Hence, references herein to ‘a predetermined date and time’ may relate to more than one specific date and time having regard to local time zones and geographic location. Therefore, any particular archive may have multiple local predetermined dates and times associated with the release of the content from the archive.

A further advantage of using the administration portal is that a publisher is able to sort and group archives with a view to determining statistics relating to various aspects of an archive's popularity, related characteristics and/or the corresponding number of downloads etc. Therefore, in preferred embodiments, the administration portal is configured to provide at least the following statistics and/or characteristics concerning a grouping of archives:
The n (e.g. 10) most popular archives based on number of key requests
The m (e.g. 10) least popular archives based on number of key requests
The number of successful key requests for one or more archives
The number of failed key requests for one or more archives
An archive popularity listing based on the total number of key requests
An archive popularity based on geographic location
An archive list based on date of creation
An archive list based on enabled or disabled archives
An archive list based on certain types/groupings of advertisements
An advertisement popularity based on the number of website accesses
An archive list based on release date

Hence, it is evident that the administration portal may provide a number of extremely useful indicators for assessing the popularity of a particular source material and/or an additional content, which may enable a publisher to tailor future archive releases to a specific sub-set of users or geographic location etc. Moreover, by way of the administration portal, management companies may determine whether particular advertising campaigns are successful and consequently can adapt subsequent marketing campaigns based on the popularity of an archive and the download characteristics of the users.

It is found that due to the significant amount of data provided to both the registration server and key server, the present invention is able to compile large datasets of information relating to properties and characteristics of users' computing environments and the users themselves. Therefore, it is relatively straightforward to identify the IP addresses of users' computers and computing devices, what type of web browsing application they may be using, their chosen operating system, their ISP, their local date and time, and as we have already discussed, the users' geographic locations and regions.

Therefore, in one respect, the invention is able to establish a relatively detailed profile of a user based on a combination of their choice of genre of downloaded source material, their download characteristics and their computing environment. In this way, the invention is able to determine a priori what source material and what, if any, advertisements may be of interest to a user, so that future archives can be tailored to users having the same or similar characteristics and interests. For example, if it is known that a large number of the users download content relating to football or soccer, then a trailer for a new football computer game can be encapsulated into an archive together with an advertisement for one or more of football merchandise, sport websites, football related books or relevant television programmes and sport DVDs etc.

As a result, the present invention provides an advantageous mechanism by which advertisements may be better targeted to users by linking the advertisement with a preferred downloadable content. It is envisaged that by encapsulating content in this way, the likelihood of enticing users to proceed to third party vendor websites may be significantly increased, leading to increased income for a website owner and possible additional sales for the vendor.

As a consequence of the significant amounts of captured data, the present invention also provides the opportunity to implement a traditional search engine functionality for website content, as well as specific search engine functionality for available downloads. The captured data provides an extremely useful resource for identifying downloads and for assessing their popularity with comparison to other archives. The ability to identify the most popular archives and download sites may be used to generate further revenue from management or advertising companies, as these will typically provide higher remuneration for the opportunity to link their advertisements into the most popular archives.

According to a second aspect of the present invention there is provided a network-based system adapted to distribute and control the release of an encapsulated content, the apparatus comprising:
an archive creation tool configured to create a self-extractable archive comprising first and second components, the second component being encrypted;
distribution means adapted to distribute the archive to one or more users; and
a remote server;
wherein in response to extraction of the archive, a request for a decryption key is transmitted to the server while the first component is presented to the user.

The archive creation tool according to the second aspect of the present invention is functionally equivalent to the corresponding tool of the first aspect of the invention and consequently either tool could be substituted for the other without departing from the invention. According to the second aspect of the invention, the archive is created such that it contains first and second components, the second component being encrypted.

The second component preferably comprises a source material that has been encrypted according to the AES encryption standard, as described in relation to the first aspect of the invention. However, other encryption standards and techniques may alternatively be used. In preferred embodiments, the second component is encrypted by way of 64 character key, but any suitable secure key length may be used.

The source material may take any form and in particular may comprise any number of files or folders, or a combination thereof. The files may include, but are not limited to, music, images, video, documents, data and software, in any desired combination. Therefore, it is evident that an archive may contain any number of different types of files, depending on the particular application and intended use of the content.

The first component preferably corresponds to an additional content, which may include, but is not limited to, any one or more of: advertising information, text-based documents, multimedia files and web-based material, which is configured to be presented to a user while a request for a decryption key is transmitted to the server. In this way, the archive is configured to include an additional functionality, so that in response to an attempt to extract the archive, the additional content can be released to a user, irrespective of whether the key is currently available for the encrypted content.

By ‘presented’ we mean any form of visual and/or audio technique of conveying information to a user. Hence, the first component may be displayed, audibly projected or both displayed and audibly projected to a user in response to an extraction event.

The distribution means is preferably a download server, and most preferably a web server, that is connected to the Internet. However, it is to be appreciated that archives may alternatively, or additionally, be distributed by way of a FTP server, via email, or by way of removable media, such as CD-ROM, DVD, a USB pen drive or tape etc. or in any other suitable way.

The remote server is preferably a key server that is connected to the Internet and is remotely located with respect to both the archive creation tool and to the distributed archives. The role of the server is to allow a publisher of an archive to control the release of an encrypted content to a user. This is achieved by providing a decryption key in response to a request from the archive. In this way, even if multiple copies of the archive have been distributed across the Internet, none of the users are able to access the content until the server releases the key.

The archive is configured to be ‘self-extractable’, in the sense that, the archive is preferably an executable file comprising integral instructions that instruct the file how to unwrap and release the encapsulated content without relying on any external software on the user's computing device. In this way, the user can avoid the need to have any external extraction software on his device and can extract the archive by simply executing the file itself.

In executing the file, the user initiates extraction of the contents, which due to the inherent intelligence of the archive generates a request, preferably in the form of a message, that is transmitted to the key server. The message is preferably sent over the Internet to the key server, whereupon the message is processed and the key is returned, subject to any prescribed restrictions.

The generation and transmission of the request is preferably an automatic and seemless task that is carried out without the user's intervention or interaction. While this task is being executed, the archive proceeds to present the first component to the user, which in some embodiments may entail displaying an advertisement to the user while he waits for the decryption key.

It is to be appreciated that the forgoing references to ‘while’ are not intended to be limited to precisely concurrent or simultaneous activities, and therefore it should be understood that the request for the key may actually occur substantially prior to or substantially subsequent to the presentation of the first component to the user, without departing from the second aspect of the invention.

Hence, it is evident that the network-based system according to the second aspect of the present invention is particularly advantageous, as the additional functionality of the archive allows related content to be linked to a downloadable content, which may then be presented to a user as part of the extraction procedure. Since there is a short delay before the encrypted content is made available, there exists a greater opportunity for a user to be enticed by the related content, which in the case of an advertisement, may encourage the user to follow a link to a vendor's website etc.

In the same manner as discussed in relation to the first aspect of the present invention, the remote server may be configured to withhold the decryption key until after a predetermined date and time. In this way, a publisher may then remotely control the release of an encrypted content by specifying how and when a key is to be released to one or more users. The functionality of the remote server may be equivalent to that of the previously described key server and therefore the earlier description applies equally to this aspect of the invention.

The networked-based system of the second aspect of the invention may further comprise a registration server and an administration portal, the respective functionality of which is preferably equivalent to that previously described. Hence, the forgoing description in respect of the first aspect of the invention applies also to the corresponding features of the second aspect of the invention.

According to a third aspect of the present invention there is provided an archive creation tool adapted to create a self-extractable archive, the tool being configured to implement the steps of:
identifying first and second components for encapsulation within the archive;
generating a random key;
encrypting the second component with the key;
encapsulating the first and second components within the archive;
and
appending extraction instructions.

The archive creation tool according to the third aspect of the invention may be used in conjunction with the network-based systems described in either of the first and second aspects of the invention, and is consistent with any of the described embodiments. The details discussed previously in relation to the archive creation tool apply equally to this aspect of the invention.

The ability to create an archive having at least two components gives rise to an archive file having additional functionality, in that, content related to the encrypted content can encapsulated within the same file and be presented to a user during the extraction procedure. In the case of advertising campaigns, it is therefore possible to include advertising material within the archive that is better targeted to a user, as the material can be selected to be complementary to the encrypted content.

According to a fourth aspect of the present invention there is provided a server arranged to provide a key to decrypt content within a self-extractable archive, the server being configured to implement the steps of:
receiving a request for a decryption key;
verifying the request as being authentic; and
releasing the key only if the request is received on or after a predetermined date and time.

The details discussed previously in relation to the key server apply equally to this aspect of the invention. The server of the fourth aspect of the invention may therefore be used in conjunction with any of the preceding aspects and embodiments.

According to a fifth aspect of the present invention there is provided a self-extractable archive, comprising:
a first part including instructions for extracting the archive; and
a second part comprising first and second components, the second component being associated with a content requiring a key for extraction, while the first component is arranged to automatically release a related content in response to an extraction request.

The self-extractable archive according to the fifth aspect of the invention may be used in conjunction with any other aspect of the invention, and thus is consistent with each previous embodiment.

The self-extractable archive is preferably in the form of a stub-executable file. However, any other self-contained file type may alternatively be used. The stub-executable file comprises first and second parts, the first part preferably corresponding to a block of executable code including instructions for extracting the archive. The stub-executable is configured to communicate with the key server in order to send a request for the decryption key. The instructions for generating the request and all other event information are included within the executable code.

The second part comprises first and second components. The first component preferably corresponds to an additional content, which may include, but is not limited to, any one or more of: advertising information, text-based documents, multimedia files and web-based material, which is configured to be presented to a user in response to an attempt to extract the archive. In preferred embodiments, the additional content may be an ad-code that has been processed during archive creation to prevent tampering with the code. Preferably, the processing of the ad-code involves obfuscating the HTML using an exclusive OR function (i.e. XOR). However, any other suitable technique may be used to preserve the integrity and security of the additional content.

In preferred embodiments, the additional content is presented to a user during the extraction procedure, in a manner as described in relation to previous aspects of the invention.

The second component is preferably in the form of a data container that is configured to include one or more encrypted files (e.g. source material), requiring a decryption key for release. The data container is commonly referred to as a ‘payload’ and the encrypted content is packed within the payload as part of the encapsulation procedure.

The payload preferably includes at least one header and one or more structural blocks, which contain information required to manage the unpacking process of the payload. Each encrypted file will preferably have at least one block associated with the packed data. However, it is to be appreciated that any other suitable payload structure may alternatively be used without departing from this aspect of the invention.

The stub-executable may also include a ‘welcome message’ that is presented to a user during extraction of the archive. The welcome message is preferably a text-based message that conveys salutations and/or useful information (e.g. version number and extraction instructions) to the user to enhance their experience and enjoyment of using the archive. The welcome message may also be accompanied by one or more graphics or icons that may be specific to the content or to the publisher who created the archive.

In preferred embodiments, the stub-executable is configured to include further instructions, which cause the file to generate an extraction tool in the form of a standalone window on the user's computing device. The function of the window is to provide an environment in which any additional content may be presented to the user, along with any welcome message or icon etc. In the case of advertising material, the window is preferably configured to automatically adjust its size to the prescribed display dimensions of the advertisement. Where the advertisement derives from an ad-code, the window is preferably arranged to include an embedded browser within a dedicated region of the window. The browser being configured to display the advertisement to the user as a web document.

The window may include further functionality by providing one or more ‘clickable’ buttons, most preferably an ‘Extract’ button and a ‘Browse’ button. The role of the Extract button is to initiate extraction of the encrypted content, while the role of the Browse button is to allow a user to select a location (e.g. destination folder) on his computing device into which the archive is to be extracted.

Preferably, the act of clicking the Extract button triggers the generation of a key request, which is then automatically transmitted to the key server for appropriate response.

In order to further encourage a user to review the additional content, the Extract button may be disabled for a prescribed interval of time before allowing a user to proceed. Once the interval elapses, the button may then be enabled, whereupon the user can click the button to initiate decryption of the content. The interval of time is preferably in the range of 3 to 8 seconds, and is most preferably 5 seconds. However, any desired interval may be used depending on the particular application and time required to review the additional content.

An advantage of this functionality is that the delay improves the chances of a user actually reviewing the additional content before proceeding to extract the archive, which in the case of advertisements, may lead to increased revenue for the publisher, if the user is enticed to proceed to a vendor's website.

The window may also include an indicator to display the progress of the extraction procedure, preferably showing the extent of the unwrapping as a function of time.

According to a sixth aspect of the present invention there is provided a network implemented method of distributing and controlling the release of an encapsulated content, the method comprising the steps of:
creating a self-extractable archive comprising an encrypted content;
distributing the archive to one or more users; and
remotely controlling the release of the content from each distributed archive by providing a decryption key in response to a key request made on or after a predetermined date and time.

The present invention also relates to a computer readable medium including at least computer program code executable by a data processing device to carry out the method of distributing and controlling the release of an encapsulated content, according to the sixth aspect of the invention.

Although the present invention is ideally suited for distributing and controlling the release of an encapsulated content, having particular application to targeted advertising, it is to be appreciated that the invention may be applied to many other applications without sacrificing any functionality or any of its advantages. For example, it is envisaged that the timed release capability would be particularly advantageous for disseminating any time sensitive data, including financial reports, stock market analyses, examination papers, as well as electronic tickets for concerts and exhibitions etc.

In the case of distributing examination papers, the whole process of providing papers, verifying successful completion and tracking marking progress can be based on the system of the present invention. For instance, archives may be distributed in advance of the examination date and could be subsequently printed just prior to the examination after release of the key. Since the examination board would know who had registered for the examination, security could be increased by printing papers for only verified candidates. Each paper would ideally incorporate some form of security device, such as a unique barcode. After completion of the examination, each paper could be scanned by way of a barcode reader and the candidates record could be correspondingly updated on a central database. Thereafter, following the return of the papers to the examination board, the progress of the marking could be tracked by way of a dedicated application, such as a web-based application. Once all marking was complete, a new archive could be distributed to each of the candidates, whereupon the key could be released on a predetermined results day.

Due to the inherent integrity of the present archive, neither the papers nor the results would be accessible to a candidate before the board intend to release them.

Another application for which the present invention would be particularly suited is in distributing electronic tickets (e-tickets) for concerts, performances and exhibitions etc. Internet ticket sales are very popular due to the ease and convenience of ticket websites. Moreover, for ticket promoters themselves, websites offer a valuable forum by which they can reduce point-of-sale costs and improve efficiency of service. However, there are a number of potential disadvantages associated with distributing tickets via the Internet. In particular, the emergence of secondary markets for the re-sale of tickets for events that have been ‘sold out’ or are otherwise difficult to obtain. This trend towards ‘black market’ ticket sales allows profiteers to re-offer tickets at often extortionate prices, which is unfair to genuine buyers, while also denying additional revenue to the promoters and record companies.

Moreover, it may also be the case that some of the offered tickets may not actually be genuine and consequently a buyer can frequently pay considerable sums of money for worthless tickets.

The present invention could mitigate against the re-sale of tickets by way of withholding the actual printable e-ticket until shortly before the performance. In one embodiment, a buyer would be required to upload a photograph or image of himself to a ticket server. The image would then be encapsulated within an archive containing the authentic ticket. The archive could then be distributed to the user in advance of the performance. Just prior to the performance the key would be released, allowing the buyer to print his e-ticket bearing his image. The re-sale of tickets would consequently be hindered, as buyers would be unlikely to pay for an archive, if they did not know what it actually contained. Furthermore, even if a buyer was convinced to purchase an unverified archive, the resulting ticket would be of little use as the image of the original buyer would be different to that of the new ticket holder.

The above example is just one possible way of implementing the present invention as a ticket sale system and therefore other techniques may alternatively be used in conjunction with the invention to achieve the advantage of reducing the likelihood of secondary ticket markets.

Although the preceding section has discussed application of the invention to the sale of tickets for events, it should also be appreciated that with suitable modification, such a system could also be employed for the sale of tickets for flights, cruises, excursions or popular tourist attractions etc.

It is envisaged in some embodiments that the archive creation tool may be embedded into a web application for use as a ticket dispenser. In such a case, a user would be required to log onto a ticket website so as to purchase a ticket for an event. The embedded archive creation tool would then automatically generate an e-ticket, which would be encapsulated into an archive for distribution to the user. For added security, the application could request that an image of the user be uploaded for inclusion within the archive, as described above.

A further application of the present invention may also be to generate revenue for a download site, irrespective of any advertising revenue that may also be accrued. In this case, the archives may be made available for download via a mobile phone or other portable communications device. A user would therefore download an archive of choice, but in order to extract the archive, he would be required to preferably send a SMS or other text-based message to the download site. The message would preferably be sent via a premium rate line, the revenue from which would be used as part or full remuneration for the cost of providing the download. If advertising content were also to be included within the archive, the publisher could then potentially generate two revenue streams for the same archive, one from download payments and another from remuneration from the management company.

Notwithstanding the inherently high levels of security and integrity associated with the present invention, one or more additional security features may also be incorporated within any of the preceding embodiments, consistent with each aspect of the invention.

For example, a personal identification number (PIN) and/or password may be attached to a particular archive, such that a user is prompted to enter the PIN and/or password in order to extract the archive. The key server would be configured to withhold the key until a valid PIN and/or password was communicated to it, e.g. in the key request or via a separate SMS-based message etc.

If a particular source material was of a sensitive or confidential nature, the archive could be configured to automatically delete the material in response to several incorrect attempts at entering the PIN and/or password. For instance, if a user were to enter an incorrect PIN, e.g. via 3 consecutive attempts, the archive would act to destroy the encrypted contents, irrespective of whether the key had been released or not.

To increase security even further, one or more biometric devices may also be used to authorise access to an archive. Hence, in similar fashion to provision of a PIN or password, the archive could prompt a user to provide biometric data, preferably a fingerprint, in order to extract the archive. The biometric data may be registered with the key server and linked to an archive of choice. A user would then simply place their finger against a suitable keyboard scanner, which would either grant or refuse access to the source material.

Another option for increasing security is the use of smart cards, which may have particular application for gaining access to remote archives. In this case, additional security may be provided by way of a PIN or password, and/or by verifying the user against a registered image of himself.

Embodiments of the invention will now be described in detail by way of example and with reference to the accompanying drawings.

### BRIEF DESCRIPTION OF THE DRAWINGS

FIG. 1 is a schematic view of a part of a networked-based system according to one embodiment of the invention, illustrating archive creation.

FIG. 2 is a schematic view of a corresponding part of the system according to the embodiment of FIG. 1, showing publication and management of the archive.

FIG. 3 is a schematic view of another part of the system according to the embodiment of FIG. 1, showing distribution and extraction of the archive.

FIG. 4 is a screenshot showing a user interface of an archive creation tool according to a particularly preferred embodiment of the invention.

FIG. 5 is another screenshot showing a different aspect of the user interface of FIG. 4.

FIG. 6 is a schematic view of the contents of an example archive.

FIG. 7 is a schematic view of the internal structure of the archive of FIG. 6.

FIG. 8 is a screenshot of an example extraction tool presented to a user during extraction of the archive.

### DETAILED DESCRIPTION OF THE PREFERRED EMBODIMENTS

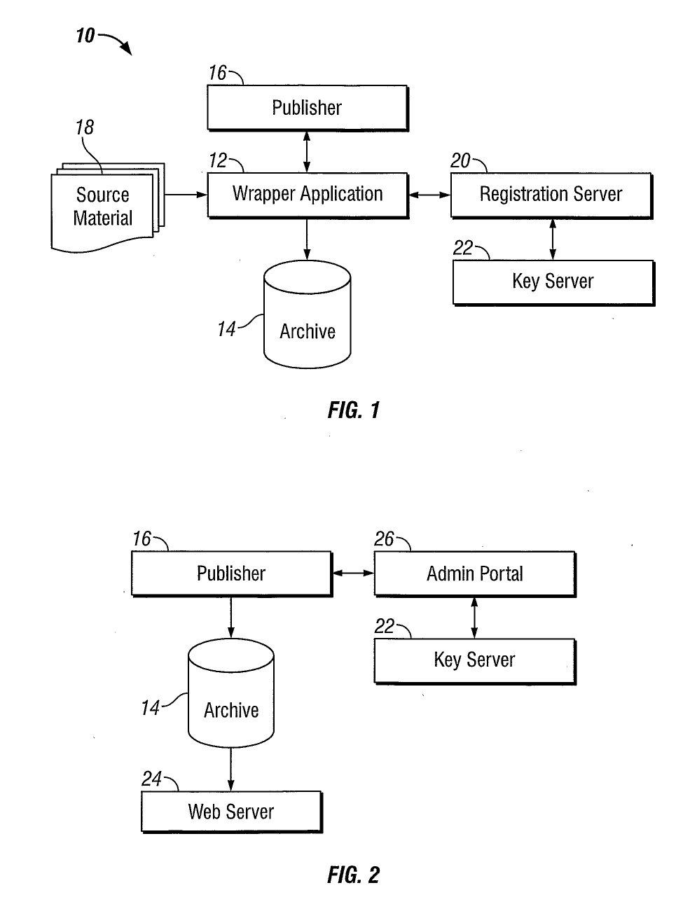

Referring to FIG. 1, there is shown a particularly preferred embodiment of a network-based system according to one or more aspects of the invention. The system 10 comprises an archive creation tool 12, referred to hereinafter as a ‘Wrapper Application’, that is configured to create a self-extractable archive 14 comprising an encrypted content.

The Wrapper Application 12 is a Microsoft Windows-based application that is installed and implemented on a publisher's desktop computer. In this embodiment, the publisher 16 is an individual who is responsible for creating archives and for publishing them on the Internet, i.e. making them available for download. The publisher 16 interacts with the Wrapper Application 12 in order to encapsulate a desired content within the archive 14. The desired content comprises a source material 18, which can include any number of files or folders, or a combination thereof. The files can be music, images, videos, documents, data, games and software, in any desired combination, depending on the particular application and use of the archive 14.

The source material 18 may also include an additional content, such as advertising information, text-based documents, multimedia files or web-based documents, so as to impart extra functionality to the resulting archive.

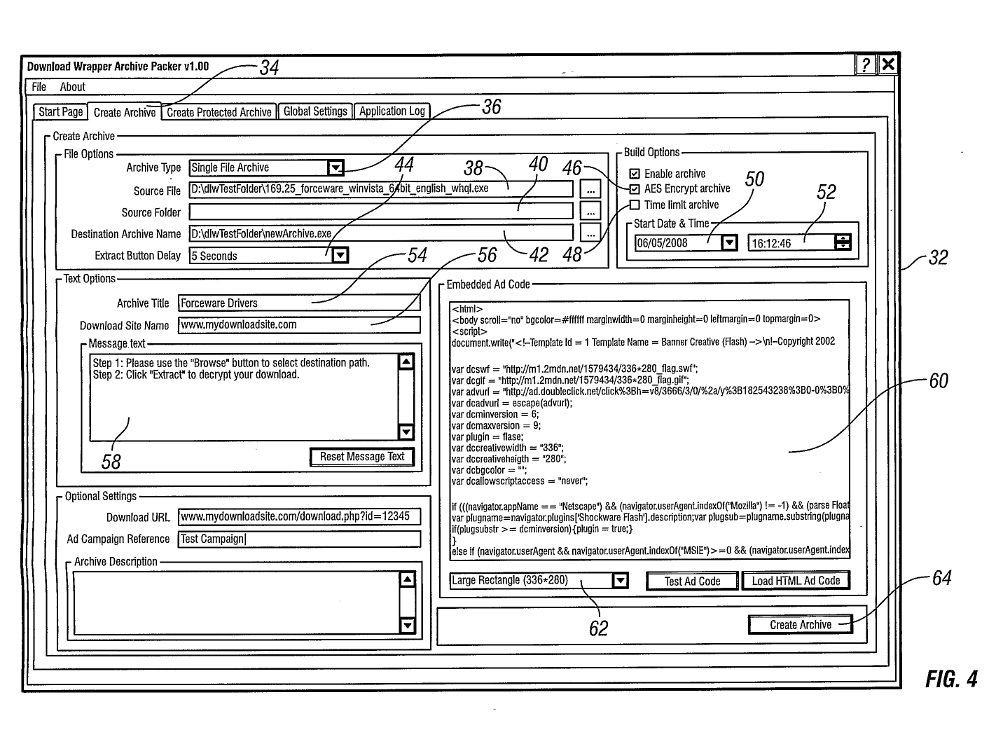

The steps involved in creating an archive will now be discussed with reference to FIG. 4, which illustrates an example graphical user interface (GUI) according to a particularly preferred embodiment of the invention. The GUI 32 forms part of the Wrapper Application 12 and provides a user-friendly interface to facilitate creation of the archive 14. A publisher 16 executes the Wrapper Application 12 within his desktop environment, and as a result, the GUI 32 is displayed to him. In order to create a new archive, the publisher 16 selects the corresponding ‘Create Archive’ tab 34 within the GUI 32.

In response to selecting the ‘Create Archive’ tab 34, the publisher 16 is presented with a page as shown in FIG. 4, comprising a number of different fields, respectively labelled as ‘File Options’, ‘Build Options’, ‘Text Options’, ‘Embedded Ad Code’ and ‘Optional Settings’. By selecting various parameters within one or more of these fields, the publisher 16 is able to create an archive having any desired optional attributes and characteristics, thereby enhancing the flexibility of the archive creation process.

In the File Options field, the publisher 16 may select the archive type, by way of a drop-down box 36. The archive type may either correspond to a single file archive or a folder archive. As shown in the example of FIG. 4, the new archive is to be a single file archive. The next step is to then chose the source material 18 for inclusion within the archive 14. This step is readily achieved by providing the path to the relevant file or folder in the sub-field ‘Source File’ 38 or ‘Source Folder’ 40, as required. In this case, only one source file (a Windows executable file .exe) is to be included. The path may be entered directly by the publisher 16, or more usually can be obtained by ‘browsing’ available directories and folders, provision for which is included within the GUI 32.

Once the source material 18 has been identified, the publisher 16 may then specify a destination name for the archive. This name is entered into the ‘Destination Archive Name’ sub-field 42 in GUI 32. The destination file will therefore correspond to the newly created archive.

The archive can be configured to include a prescribed delay in relation to disabling an ‘Extract button’, which is discussed in more detail later. The delay can be selected from a drop-down box in sub-field ‘Extract Button Delay’ 44, and is ideally set to 5 seconds. A 5 second delay has been found to be the optimum interval for making a user 28 wait to extract the archive 14. Any longer and the user 14 may lose interest or become annoyed.

Having completed the sub-fields in the File Options field, the publisher 16 may then proceed to select desired parameters within the neighbouring ‘Build Options’ field. This field permits a publisher 16 to invoke data encryption and to selectively control the release of the source material 18, such that the archive 14 may only be extracted on or after a predetermined date and time. In the example of FIG. 4, the publisher 16 has decided to encrypt the source material 18 by way of an AES encryption standard (tick box 46) and has set a prescribed date and time for the release of the encrypted content (see tick box 48 and drop-down boxes 50 & 52). In this way, extraction of the archive 14 cannot take place until that date and time.

The publisher 16 has the option to include various pieces of information in the archive 14, by inserting text in the Text Options field. Within this field, the archive 14 may be given a title by entering text into the ‘Archive Title’ sub-field 54. This title will be subsequently displayed during extraction of the archive 14. Further information, such as the URL of the download site may also be entered (see sub-field ‘Download Site Name’ 56), together with any welcome message or instructions to the user 28. The message and/or instructions can be typed into the ‘Message Text’ sub-field 58, as shown in FIG. 4.

At this point, the publisher 16 can decide to include any additional content, which in the example of FIG. 4, corresponds to an embedded ad-code. The ad-code is typically provided by a third party management company and is in the form of a HTML code segment. The HTML usually includes at least one target URL address, from which an advertisement can be downloaded for display to a user 28 during extraction of the archive 14.

The ad-code can simply be inserted into the ‘Embedded Ad Code’ sub-field 60 by a conventional ‘cut and paste’ action. Alternatively, the HTML code may be entered manually by typing, if necessary. Provision can also be made for automatic loading of the ad-code by electronic transfer from a management company or advertiser etc.

The publisher 16 has direct control over the size of the advertisement and can select, via drop-down box 62, the display dimensions of the advertisement. Should the publisher 16 want to preview the advertisement prior to creation of the archive, provision is made within the GUI 32 to test the ad-code to ensure that the code and URL are operating correctly.

When a publisher 16 is satisfied that all the properties of his new archive have been defined and set within the GUI 32, he can then click on the ‘Create Archive’ button 64 to create the archive 14. The Wrapper Application 12 then proceeds to wrap and encapsulate the content into the archive 14 and saves it at the specified location on the publisher's desktop computer.

Referring again to FIG. 1, the system 10 further comprises a registration server 20 and a key server 22. The role of the registration server 20 is to register and validate a newly created archive by communicating with the Wrapper Application 12 during the creation of the archive 14. The preceding sections described in detail the steps taken by a publisher 16 to create a new archive 14, however there are number of additional ‘background steps’ that take place without the knowledge of the publisher 16 and without any need for his intervention.

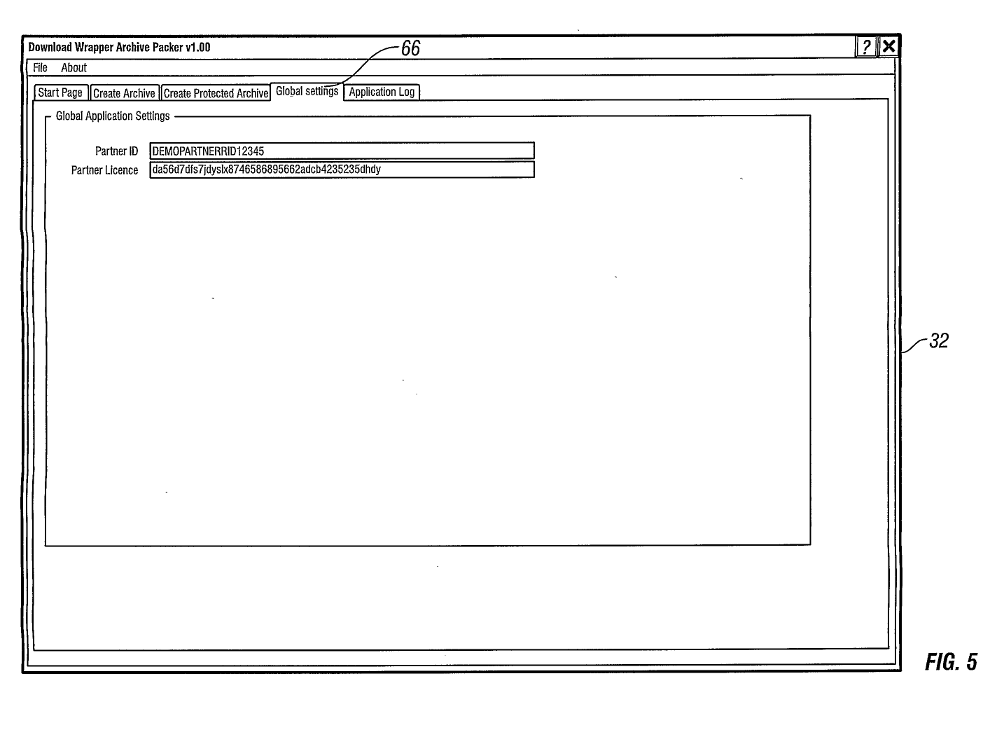

The background steps make use of the functionality of the registration server 20 in order to register and validate the archive during its creation and subsequent distribution to a user 28. Once a publisher 16 instructs the Wrapper Application 12 to create the archive 14, the Wrapper Application 12 sends both an identifier and licence details, which are each unique to the publisher 16, to the registration server 20. The identifier is referred to herein as the ‘Partner ID’ and the licence details are known as the ‘Partner Licence’. Both the Partner ID and Partner Licence may be provided to the Wrapper Application 12 by way of the ‘Global Settings’ tab 66 in GUI 32, as shown in the example of FIG. 5.

The use of a Partner ID and Partner Licence enhances the security of the system 10, as only verified and validated publishers are allowed to create and publish archives by way of the system 10.

At the time the Partner ID and Partner Licence are sent to the registration server 20, the Wrapper Application 12 also requests a new download identifier for the archive 14. This identifier is referred to herein as the ‘Download ID’. The registration server 20 compares the Partner ID and Partner Licence with the publisher's pre-registered details in order to verify the request for the Download ID. If the transmitted details are invalid, the registration server 20 will return an error code or error message and the publisher 16 will then be prompted to re-send the validation details again.

If, however, the transmitted details are found to be valid, the registration server 20 will then return a unique Download ID for the new archive 14, and will create a local pending record for that archive. The pending record includes at least the following fields:
A unique record identifier (URID)
The Partner ID
A timestamp corresponding to the date/time of the request
The Download ID

Upon receiving the Download ID, the Wrapper Application 12 proceeds to generate a random 64 character encryption key, according to the AES encryption standard. The key is used to encrypt the source material 18 prior to encapsulation within the archive 14. The encrypted files or folders are then packed into the archive 14, together with the executable code required to extract the archive in the absence of any external extraction software. At this stage, any welcome message and/or instructions are also inserted into the archive 14, and if an additional content, such as an ad-code, has been provided this too is then encapsulated within the archive file.

To prevent any tampering with the ad-code within the archive 14, the Wrapper Application 12 obfuscates the HTML code using a simple exclusive OR (i.e. XOR) function prior to encapsulation.
Once the wrapping has been concluded, the archive 14 is then structurally complete.

The Wrapper Application 12 confirms the successful creation of the archive with the registration server 20, whereupon it sends the following data and/or information to the registration server 20:
The encryption key
The Download ID
The title of the archive
A copy of the ad-code (in base 64 format)
The status of the archive (enabled/disabled)
A prescribed date and time for release
An advertising campaign reference
A download URL
A description of the archive

The registration server 20 proceeds to verify the details by comparing the Download ID with the pending record. If the Download ID matches the record, the registration server 20 creates a new permanent record for the archive 14 and deletes the earlier pending record. If, however, the Download ID does not match the record, it will then proceed to return an error message and will prompt the publisher 16 to try again.

Following registration and validation of the new archive, the registration server 20 copies the registered details (including the key) onto the key server 22.

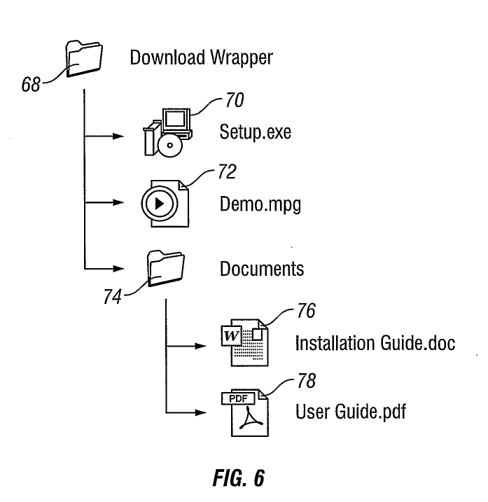

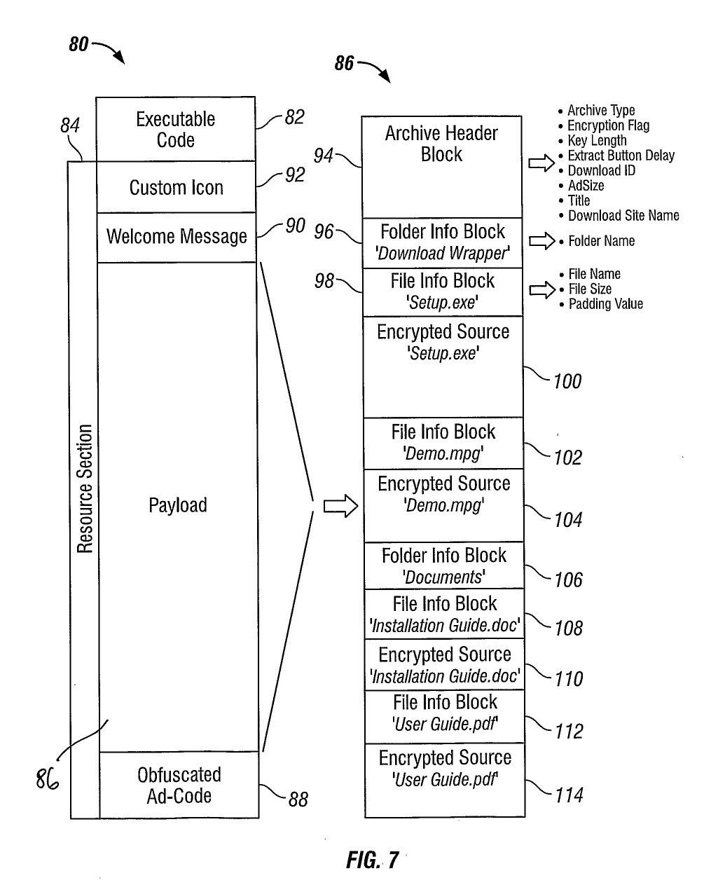

The structure of an example archive will now be discussed in more detail with reference to FIGS. 6 and 7. As shown schematically in FIG. 6, a typical archive 14 may contain a source material 18 comprising any number of files and/or folders, together with an optional additional content. In this example, an application called a ‘Download Wrapper’ comprises a folder 68 that includes two files (Setup.exe 70 & Demo.mpg 72) and a sub-folder 74 (Documents), which itself includes two files (Installation Guide.doc 76 & User Guide.pdf 78). The Demo.mpg 72 file may be a demo for a computer game or new software etc. All the files necessary to install and use the application are present within the folder 68, and this folder may be readily encapsulated within a single archive 14.

Referring to FIG. 7, the archive 14 is in the form of a stub-executable file 80 having the functionality to self-extract the contents of the file without the need for external extraction software. The stub-executable file 80 comprises executable code 82 that includes instructions to extract the archive 14 and to generate a request for a decryption key from the key server 22. The remaining structure of the stub-executable file 80, comprises a resource section 84 that contains a data container 86, herein referred to as a ‘payload’, together with any additional content 88, welcome message 90 and custom icon 92.

In the example of FIG. 7, the additional content 88 corresponds to an obfuscated ad-code, wrapped within the stub-executable 80, such that in response to extraction of the archive 14 an advertisement will be presented to the user 28.

To construct a payload 86, the Wrapper Application 12 firstly creates an empty data container into which one or more encrypted files are successively packed. The empty container is initially zero bytes in size. To commence filling the payload, an ‘Archive Header Block’ 94 is generated which contains all the fields required to manage the unpacking process when the archive file is executed. Only one header block per payload is required and it typically includes the following fields:
The archive type
An encryption flag
The Key length
The Extract button delay
The Download ID
The chosen size of the advertisement
The title of the archive
The download site name

If, as in the example of FIG. 7, a chosen source material 18 includes any folders, the Wrapper Application 12 will create a ‘Folder Information Block’ for each one. Therefore, as shown in FIG. 7, the ‘Download Wrapper’ folder 68 and the ‘Documents’ folder 74 each have a respective Folder Information Block 96 & 106. Each Folder Information Block contains a field specifying the folder name and path information for recreating the folder and file hierarchy during extraction of the archive 14.

The Wrapper Application 12 also creates a ‘File Information Block’ for each file of the source material 18 (see 98, 102, 108 & 112 in FIG. 7). Each File Information Block contains the following fields:
The filename
The file size
A padding value (used to ensure consistent 16 byte boundaries are achieved for AES encryption)

In order to fill the payload 86, it is necessary for the Wrapper Application 12 to process each file in turn. Therefore, after having created an empty payload container and generated a corresponding Archive Header Block 94, the Wrapper Application 12 continues to sequentially pack each file of the source material 18 into the payload 86. In the example of FIG. 7, the Wrapper Application 12 will initially create the Folder Information Block 96, and will then insert a File Information Block 98 for the first file, Setup.exe, into the payload 86. Thereafter, the Wrapper Application 12 proceeds to load a copy of the file into an allocated system memory, whereupon the copy is encrypted by way of the randomly generated 64 character key. The encrypted file 100 is then packed into the payload 86 directly following its corresponding File Information Block 98, as shown in FIG. 7. This process is then repeated for each file and folder, until all have been processed and the payload 86 has been filled (see 98 . . . 114 in FIG. 7).

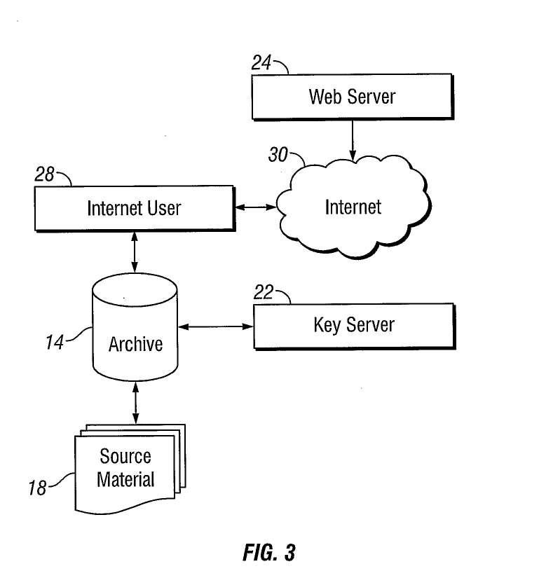

Referring now to FIGS. 2 and 3, after an archive 14 has been created by the Wrapper Application 12, the publisher 16 is able to make the archive 14 available for download via the Internet 30. The publisher 16 may transfer the archive 14 to a conventional web server 24, using any suitable technique, e.g. FTP or email etc. Thereafter, at some future point in time, a user 28 can select and download the archive 14 using a web browser or other file download mechanism. It is to be appreciated however, that the archive 14 could be distributed in other ways, such as via email or by physically exchanging removable media, e.g. CD-ROM, DVD, USB pen drives etc., without sacrificing any of the advantages of the present invention.

Once the user 28 has obtained the archive 14, he can then execute the file on his computing device (e.g. desktop or mobile etc.) to extract the original source material 18.

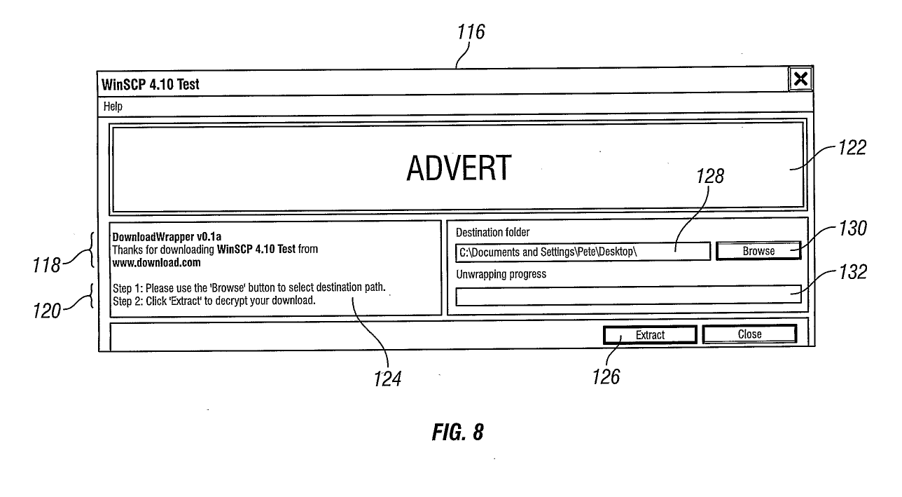

The stub-executable 80 contains all the necessary code and information in order to perform the sequence of events that lead to extraction of the contents, along with knowledge as to how to unpack the data. When the stub-executable 80 is executed, it creates a temporary file on the user's computing device, and proceeds to display an extraction tool to the user 28, in the form of a dedicated, standalone window 116, as shown in FIG. 8. The contents of the window 116 will depend on the parameters and properties that were selected and set by the publisher 16 during creation of the archive 14. However, in the example of FIG. 8, it is evident that the publisher 16 has included a welcome message 118, extraction instructions 120 and an ad-code within the archive 14, each of which have led to information being presented to the user 28 in response to extraction of the file. The welcome message 118 and extraction instructions 120 are displayed within their own dedicated text box 124, in order to provide helpful commentary to the user 28.

During execution of the stub-executable 80, the obfuscated HTML ad-code 88 is converted back to its original form and the integrity of the ad-code is checked against the base 64 version stored on the key server 22. If the ad-code is deemed to be valid, the HTML code is written to the temporary file and the corresponding advertisement 122 is then presented to the user 28. The advertisement 122 is displayed within an embedded browser, which is directed to the HTML within the temporary file. The embedded browser is completely contained within the window 116, which is automatically sized to suit the size of the advertisement that was defined by the publisher 16 during creation of the archive 14.

The advertisement may be static or animated, or may combine both static and animated elements, depending on the particular application and desired advertising campaign.

The window 116 further comprises an ‘clickable’ Extract button 126, which is used to initiate extraction of the encrypted content within the archive 14. The Extract button 126 is ‘disabled’ (e.g. blanked out) for a prescribed interval of time, ideally 5 seconds after the window is displayed, in order to encourage the user 28 to view the advertisement 122 before proceeding to access the encrypted content. The interval of time is defined by the publisher 16 during creation of the archive 14 (see above). Once the Extract button 126 becomes enabled, the user 28 may then continue with the extraction procedure, simply by ‘clicking on’ the button 126.

The user 28 has the option of specifying a location or destination folder in which the archive 14 is to be extracted. He may enter a path location or ‘browse’ available directory hierarchies on his computing device via functionality within the window 116. A path text box 128 and ‘Browse button’ 130 are provided for this purpose.

For the user's convenience, a progress bar indicator 132 is also provided within the window 116 to display the progress of the unwrapping procedure.

By clicking on the Extract button 126, the user 28 initiates a request for a decryption key from the key server 22. If contact cannot be made with the key server 22, the user 28 is prompted, by way of a dialogue box, to check that his Internet connection is active and operating correctly. Assuming that contact is established, the stub executable 80 obtains the Download ID from the Archive Header Block 94 and queries the key server 22 for the corresponding decryption key (which is the same as the 64 character key used to encrypt the source material 18). In response, the key server 22 searches its internal database for a matching Download ID. If no matching Download ID is found, the key server 22 notifies the stub-executable 80, which in turn instructs the user 28 that an error has occurred and suggests to the user 28 that the archive 14 be downloaded again due to possible corruption of the file.

If, however, a matching Download ID is found, the key server 22 will proceed to verify the status of the archive 14 and will determine whether any events and/or conditions have been registered in respect of the archive 14.

Depending on the status of the archive 14 and whether or not any events and/or restrictions have been applied to the archive 14, there are a number of different responses that the key server 22 may make when actioning a request for a key.

The responses, with respect to certain conditions, may be set out as follows:

1. No available key
a. The key server 22 will respond by sending an error message to the extraction tool.
b. The user 28 will be notified via a relevant error message.

2. Available key but archive is disabled
a. The key server 22 will respond by notifying the extraction tool that the archive is currently disabled. The key server 22 may send a custom message indicating the reason for why the archive is disabled, e.g. due to virus or malware etc.
b. The key is withheld.
c. The extraction tool notifies the user 28 accordingly.

3. Available key, archive is enabled but release is time limited
a. The key server 22 will respond by notifying the extraction tool that the archive is marked as time limited & will provide the date and time at which the key is to be released.
b. The key is withheld until after the specified date and time.
c. The extraction tool notifies the user 28 as to when the key will be released.

4. Available key, archive is enabled and time limit has elapsed or is non-time limited
a. The key is released and sent to the user 28, along with any messages defined by the publisher 16.

In situations where the key is released to a user 28, the stub-executable 80 proceeds to extract the encrypted content by applying the decryption key to the data and converting it back into its original form. Thereafter, the source material 18 is available to the user 28 and can be stored on his computing device at the location of the destination folder.

Communication between the extraction tool and the key server 22 is accomplished by way of HTTP and HTTPS transfer protocols. The use of the HTTPS protocol ensures that the file transfer between the extraction tool and key server 22 is secure. However, it is to be appreciated that any other suitable secure file transfer mechanism may alternatively be used. For instance, in other embodiments, the distribution of the key may be possible over DNS (Domain Name Service) by way of unique name resolution lookups.

A ‘lookup request’, preferably in the form of a DNS request, would be transmitted to a name server that is configured to provide a decryption key in response to the request. The name server would be capable of resolving Internet domain names, so that in response to a DNS request, the server could reply with a null IP address, or an IP address representing some form of status code having meaning to the archive. Having resolved the name, the name server could then return a DNS record, in which one of the record fields (or other component) would contain the decryption key, and one or more other fields may include messages and/or instructions for the archive user. The use of DNS lookup requests is believed to be particularly advantageous, as domain name resolution can be used to distribute keys to archives within environments that do not support HTTP or HTTPS transfer mechanisms, but do allow name resolution.

It is to be understood that DNS functionality may be used with any of the embodiments of the present invention.

In order to manage an archive and/or to alter one or more properties or events associated with an archive 14, a publisher 16 may use the administration portal 26, as shown in FIG. 2. The administration portal 26 is a web-based application that resides on top of the key server 22, as an application layer. A publisher 16 may view the details of his archive 14 and can modify the status and/or any restrictions associated with an archive. Hence, for example, should a publisher wish to re-schedule a release date for a key, he could use the administration portal 26 to change the registered date and time for that archive. Moreover, should it become necessary to disable access to an archive, for instance, due to it becoming known that a virus or malware has been found in that archive, a publisher 16 can act swiftly to disable the archive, so as to prevent spreading the virus amongst further users.

A number of possible modifications may be made to the system as described above, all of which are consistent with the present invention. In particular, it is noted that the manual insertion of ad-codes may become an onerous, and potentially protracted, procedure if a publisher generates significant numbers of archives. Hence, a possible alternative may be to modify the registration server 20 so that it would provide an ad-code directly to the Wrapper Application 12 during creation of the archive 14. In one sense therefore, the registration server 20 would automatically ‘push’ ad-codes into the Wrapper Application 12. As a result, significant manpower may be saved, as the inclusion of an ad-code would become an automatic process. Moreover, by making use of such functionality, the Wrapper Application, and in particular, the GUI 32 could be greatly simplified, making the overall archive creation more efficient and user-friendly.

In such a case, a publisher 16 would only need to enter basic details concerning the source material 18, which would then allow the registration server 20 to match an appropriate ad-code to the content. The publisher 16 would not be directly involved in the matching process (as this takes place on the registration server 20), but would be able to test and review the ad-code during the creation process to ensure that the advertisements are acceptable and appropriate for that content.

The registration server 20 would have to be modified to include this additional functionality, and would also need to be directly linked to management companies and advertisers, so that ad-codes could be directly obtained from them for sending to the Wrapper Application 12.

During the archive creation process, the publisher 16 would select a field which denotes that an ad-code is needed. This information would be sent to the registration server 20 at the time a Download ID is requested, together with one or more searchable keywords to improve the ad-code matching procedure. The registration server 20 would use the keywords to identify a relevant ad-code, which would then be returned to the Wrapper Application 12. If no suitable ad-code could be found, a generic ad-code may alternatively be provided.

Although the above embodiments have been described in specific detail with reference to advertising, it is to be understood that the present invention has many other potential applications and consequently it is not intended to be solely limited to the encapsulation of ad-codes and advertising material.

The above embodiments are therefore described by way of example only. Many variations are possible without departing from the invention.

What is claimed is:

1. A network-based system adapted to distribute and control the release of an encapsulated content, the apparatus comprising:
an archive creation tool configured to create a self-extractable archive comprising an encrypted content;
distribution means adapted to distribute the archive to one or more users; and
a server arranged to remotely control a timed release of the content from each distributed archive by providing a decryption key in response to a key request received on or after a predetermined date and time.

2. The system as in claim 1, wherein the archive is configured to send the key request to the server in response to an extraction event.

3. The system as in claim 2, wherein the server is configured to refuse any key request prior to the predetermined date and time.

4. The system as in claim 1, wherein the archive further comprises instructions to control the extraction procedure.

5. The system as in claim 1, wherein the archive further comprises an additional content which is configured to be presented to a user in response to an extraction event, the additional content selected from the group consisting of: advertising information, text-based documents, multimedia files and web-based material.

6. The system as in claim 5, wherein the archive is configured to delay the release of the decrypted content until the additional content has been presented to the user for a prescribed interval of time.

7. The system as in claim 1, wherein the distribution means is a download server.

8. The system as in claim 1, wherein the archive creation tool is further configured to generate a random key to encrypt the content during creation of the archive.

9. The system as in claim 8, further comprising a registration server configured to register and validate the archive by assigning one or more unique identifiers to the archive.

10. The system as in claim 9, wherein the archive creation tool is configured to register the generated key with the registration server.

11. The system as in claim 9, wherein the registration server is configured to provide a copy of the generated key to the decryption key server.

12. The system as in claim 1, further comprising an archive management tool configured to monitor the status and/or to modify one or more properties associated with an archive.

13. The system as in claim 12, wherein the archive management tool is configured to compile statistical data associated with each archive download.

14. The system as in claim 13, wherein the archive management tool is a web-based application.

15. The system as in claim 1, wherein the predetermined date and time is dependent on the time zone of the region into which the archive has been distributed.

16. The system as in claim 1, wherein the server is configured to require additional authentication before releasing the key.

17. The system as in claim 16, wherein the additional authentication is selected from the group consisting of: a password, a PIN and a SMS-based message.

18. A network-based system adapted to distribute and control the release of an encapsulated content, the apparatus comprising:
an archive creation tool configured to create a self-extractable archive comprising first and second components, the second component being encrypted;
distribution means to distribute the archive to one or more users; and
a remote server;
wherein in response to extraction of the archive, a request for a decryption key is transmitted to the server while the first component is presented to the user.

19. The system as in claim 18, wherein the server is configured to control the release of the second component by providing the key only on or after a predetermined date and time.

20. An archive creation tool adapted to create a self-extractable archive, the tool being configured to implement the steps of:
identifying first and second components for encapsulation within the archive;
generating a random key;
encrypting the second component with the key;
encapsulating the first and second components within the archive; and
appending extraction instructions.

21. The tool as in claim 20, wherein the first component is selected from the group consisting of: advertising information, text-based documents, multimedia files and web-based material.

22. A server arranged to provide a key to decrypt content within a self-extractable archive, the server being configured to implement the steps of:
receiving a request for a decryption key;
verifying the request as being authentic; and
releasing the key only if the request is received on or after a predetermined date and time.

23. An archive management tool in the form of an application layer, the tool being configured to implement the steps of:
communicating with a server of a type as claimed in claim 22;
compiling statistics relating to one or more self-extractable archives registered with the server;
monitoring the extraction status of the one or more archives; and
optionally, modifying one or more properties associated with one or more of the archives.

24. A computer readable medium including at least computer program data readable by a data processing device, the computer program data representating a self-extractable archive, comprising:
a first part including instructions to extract the archive; and
a second part comprising first and second components, the second component being associated with a content requiring a key for extraction, while the first component is arranged to automatically release a related content in response to an extraction request.

25. The computer readable medium as in claim 24, wherein the second component is in the form of a data container including one or more encrypted files.

26. The computer readable medium as in claim 24, wherein the first component is selected from the group consisting of: advertising information, text-based documents, multimedia files and web-based material.

27. A network implemented method of distributing and controlling the release of an encapsulated content, the method comprising the steps of:
creating a self-extractable archive comprising an encrypted content;
distributing the archive to one or more users; and
remotely controlling the release of the content from each distributed archive by providing a decryption key in response to a key request made on or after a predetermined date and time.

28. The method as in claim 27, wherein the key request is sent to a key server in response to an extraction event.

29. The method as in claim 28, comprising the further step of refusing the key request at the server prior to the predetermined date and time.

30. A network-based system adapted to distribute and control the release of an encapsulated content, the apparatus comprising:
an archive creation tool configured to create a self-extractable archive comprising first and second components, the second component being encrypted;
distribution means to distribute the archive to one or more users; and
a remote name server;
wherein during extraction of the archive, a lookup request is transmitted to the server while the first component is presented to the user, the name server being configured to provide a decryption key in response to the lookup request.

31. The system as in claim 30, wherein the name server is configured to provide the decryption key in response to a lookup request made on or after a predetermined date and time.

32. The system as in claim 30, wherein the decryption key is part of a name resolution record.

33. A computer readable medium including at least computer program code executable by a data processing device to carry out the method of distributing and controlling the release of an encapsulated content as claimed in claim 27.
